(19) United States
(12) Patent Application Publication
(10) Pub. No.: US 2017/0292462 A1
(43) Pub. Date: Oct. 12, 2017

(54) CONTROL SYSTEM FOR INTERNAL COMBUSTION ENGINE

(71) Applicant: Toyota Jidosha Kabushiki Kaisha, Toyota-shi Aichi-ken (JP)

(72) Inventor: Satoshi Tsuda, Gotemba-shi Shizuoka-ken (JP)

(21) Appl. No.: 15/455,478

(22) Filed: Mar. 10, 2017

(30) Foreign Application Priority Data
Apr. 7, 2016 (JP) 2016-077482

(51) Int. Cl. F02D 41/00; F02D 37/02; F02B 11/00; F02D 41/14; F02D 41/04; F02D 41/40

(52) U.S. Cl. CPC F02D 41/0025; F02D 41/04; F02D 41/40; F02B 11/00; F02D 41/1497; F02D 37/02; F02D 2200/025

(57) ABSTRACT

A control system for an internal combustion engine is provided with a combustion control part, an operating state judging part judging if an engine operating state is a steady state or a combustion noise is a noise transition state where the combustion noise increases over a predetermined allowable noise value when burning fuel by an ignition-assist self-ignition combustion, and an ozone supply control part controlling the amount of ozone supplied to the combustion chamber by the ozone supply system. The ozone supply control part controls the amount of supply of ozone to a predetermined reference amount when the state is judged to be the steady state and controls the amount of supply of ozone to an amount of supply smaller than the reference amount or makes the amount of supply of ozone zero when the state is judged to be the noise transition state.

### CROSS-REFERENCE TO RELATED APPLICATION

This application claims priority based on Japanese Patent Application No. 2016-077482 filed with the Japan Patent Office on Apr. 7, 2016, the entire contents of which are incorporated into the present specification by reference.

### TECHNICAL FIELD

The present disclosure relates to a control system for an internal combustion engine.

### BACKGROUND ART

JP2014-025373A discloses a conventional control system for an internal combustion engine configured so as to perform first fuel injection when the concentration of the active species in a cylinder is a predetermined value or more, then perform second fuel injection when the concentration of active species has become less than the predetermined value to burn premixed gas by a compression-ignition combustion. According to 3P2014-025373A, it is possible to divide fuel injected into a cylinder into two stages to burn the fuel by the self-ignition combustion mode, so it is considered possible to reduce the combustion noise compared with when all of the fuel is burned by the self-ignition combustion mode at one time.

### SUMMARY

However, the above-mentioned JP2014-025373A, for example, did not consider the transition state where the intake temperature and other various types of parameters having an effect on the compression-ignition combustion change transitionally in such a transition state, since the temperature inside a cylinder etc, change transitionally, the self-ignition timing also changes. For this reason, in the transition state, the fuel will not burn by the self-ignition combustion mode divided into two stages and the combustion noise is liable to deteriorate.

The present disclosure was made with such a problem in mind and includes embodiments that may suppress deterioration of the combustion noise when making the premixed gas burn by the compression-ignition combustion when the internal combustion engine is in a transition state.

To solve this problem, according to one aspect of the present disclosure, there is provided a control system for an internal combustion engine configured so as to control an internal combustion engine provided with an engine body, a fuel injector for directly injecting fuel into a combustion chamber of the engine body, a spark plug arranged so as to face the inside of the combustion chamber, and an ozone supply system for supplying ozone directly or indirectly into the combustion chamber, the control system comprising a combustion control part configured to control an injection amount and injection timing of the fuel injector and an ignition timing of the spark plug so as to cause part of the fuel to burn by the flame-propagation combustion by the spark plug and use heat generated at that time to make the remaining fuel burn by the premixing and compression-ignition combustion as an ignition-assist self-ignition combustion in the combustion chamber, an operating state judging part configured to judge if an engine operating State is a steady state or a noise transition state where the combustion noise increases over a predetermined allowable noise value when performing the ignition-assist self-ignition combustion, and an ozone supply control part configured so as to control the amount of ozone supplied to the combustion chamber by the ozone supply system. Further, the ozone supply control part is configured so as to control the amount of supply of ozone to a predetermined reference amount when the state is judged to be the steady state and to control the amount of supply of ozone to an amount of supply smaller than the reference amount or make the amount of supply of ozone zero when the state is judged to be the noise transition state.

According to this aspect of the present disclosure, it is possible to suppress the deterioration of the combustion noise when making the premixed gas burn by the compression-ignition combustion when in the transition state.

### BRIEF DESCRIPTION OF DRAWINGS

FIG. 1 is a schematic view of the configuration of an internal combustion engine and an electronic control unit controlling the internal combustion engine according to a first embodiment of the present disclosure.

FIG. 2 is a cross-sectional view of an engine body of an internal combustion engine.

FIG. 3 is a view showing an operating region of an engine body.

FIG. 4A is a view showing one example of opening operations of an intake valve and exhaust valve in a CI operating mode.

FIG. 4B is a view showing one example of opening operations of an intake valve and exhaust valve in a CI operating mode.

FIG. 5 is a view showing a relationship of an amount of fuel consumed by the compression-ignition combustion and combustion noise in the case of making premixed gas burn by the compression-ignition combustion.

FIG. 6 is a view showing a relationship of a crank angle and heat generation rate in the case of injecting a predetermined amount of fuel corresponding to the engine load from a fuel injector just one time and burning it by the compression-ignition combustion.

FIG. 7 is a view showing a relationship of a crank angle and heat generation rate in the case of burning fuel by an ignition-assist self-ignition combustion.

FIG. 8 is a view explaining a change of a heat generation rate pattern when burning fuel by an ignition-assist self-ignition combustion in the case where, as one example of a transition state, the intake temperature becomes a lower temperature than a target value.

FIG. 9 is a view explaining a change of a heat generation rate pattern when burning fuel by an ignition-assist self-ignition combustion in the case where, as one example of a transition state, the intake temperature becomes a lower temperature than a target value.

FIG. 10 is a view explaining a change of a heat generation rate pattern when retarding the injection timing and ignition assist timing of ignition assist fuel so as to retard self-ignition timing in the case of the state becoming a first transition state.

FIG. 11 is a view explaining a change of a heat generation rate pattern due to a difference in amount of supply of ozone to the inside of a combustion chamber when burning fuel by an ignition-assist self-ignition combustion in the case of the state becoming a first transition state.

FIG. 12 is a flow chart for explaining combustion control during the CI operating mode according to a first embodiment of the present disclosure.

FIG. 13 is a table for calculating a first target amount of supply of ozone based on an advanced deviation amount Tiga.

FIG. 14 is a table for calculating a second target amount of supply of ozone based on a retarded deviation amount Tigr.

FIG. 15 is a view showing an operating region of an engine body.

FIG. 16 is a flow chart for explaining combustion control during the CI operating mode according to a second embodiment of the present disclosure.

### DESCRIPTION OF EMBODIMENTS

Below, referring to the drawings, embodiments of the present disclosure will be explained in detail. Note that, in the following explanation, similar component elements are assigned the same reference notations.

### First Embodiment

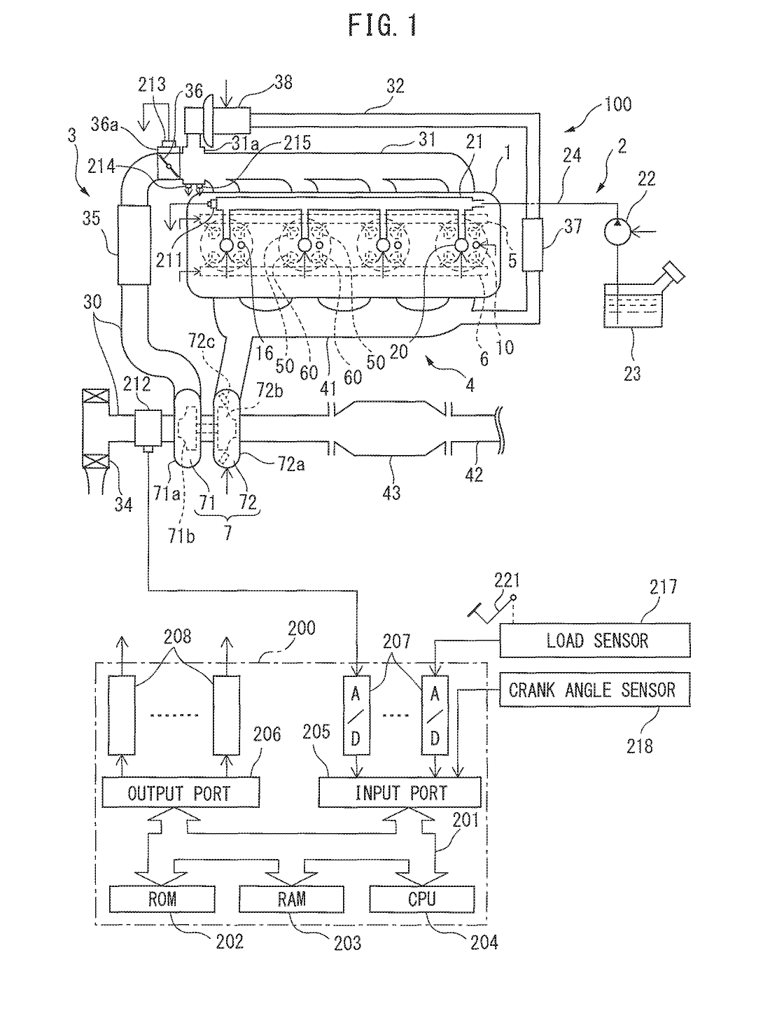

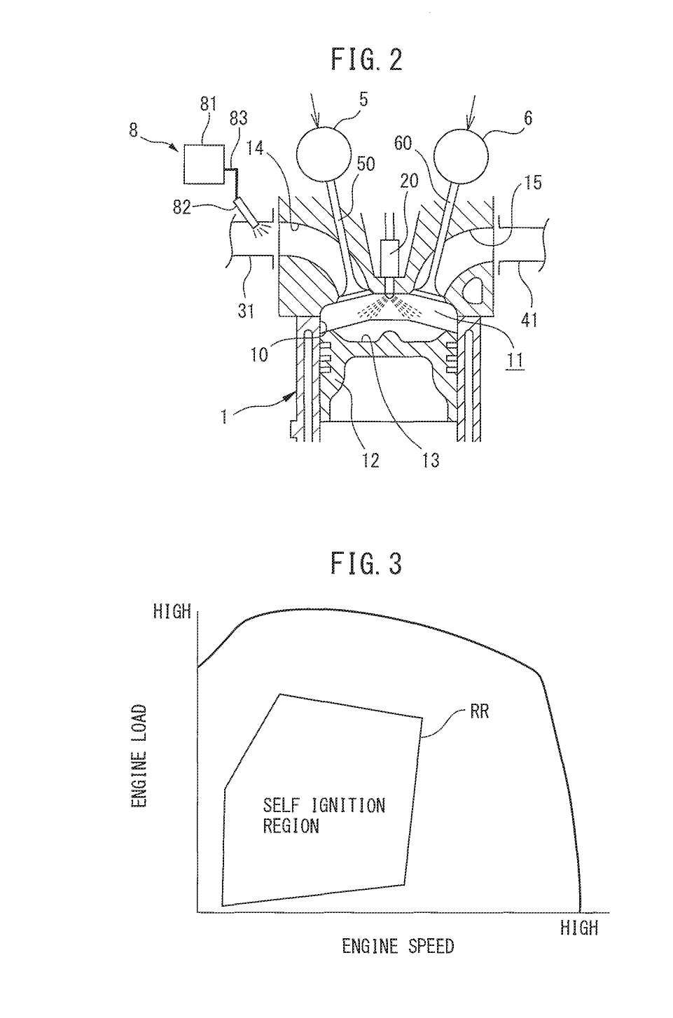

FIG. 1 is a schematic view of the constitution of an internal combustion engine 100 and an electronic control unit 200 controlling the internal combustion engine 100 according to a first embodiment of the present disclosure. FIG. 2 is a cross-sectional view of an engine body 1 of the internal combustion engine 100.

The internal combustion engine 100 is provided with an engine body 1 provided with a plurality of cylinders 10, a fuel supply system 2, an intake system 3, an exhaust system 4, an intake valve operating system 5, an exhaust valve operating system 6, and an ozone supply system. 8 (see FIG. 2).

The engine body 1 burns fuel in combustion chambers 11 formed at the cylinders 10 (see FIG. 2) to for example generate drive force for driving a vehicle etc. The engine body 1 is provided with one spark plug 16 for each cylinder facing the combustion chamber 11 of each cylinder 10. Further, the engine body I is provided with a pair of intake valves 50 and a pair of exhaust valves 60 for each cylinder.

The fuel supply system 2 comprises electronically controlled fuel injectors 20, a delivery pipe 21, a feed pump 22, and a fuel tank 23.

Each fuel injector 20 is provided at the engine body 1 so as to be able to inject fuel toward a cavity 13 formed at a top surface of a piston 12 receiving combustion pressure and moving reciprocally inside a cylinder 10 and thereby form a stratified premixed gas. In the present embodiment, the fuel injector 20 is arranged adjoining a spark plug 16. One is provided at each cylinder 10 so as to face the combustion chamber 11 of that cylinder 10. The opening time (injection amount) and opening timing (injection timing) of the fuel injector 20 are changed by control signals from the electronic control unit 200. If the fuel injector 20 is opened, fuel is directly injected from the fuel injector 20 into the combustion chamber 11.

The delivery pipe 21 is connected through a pumping pipe 24 to the fuel tank 23. In the middle of the pumping pipe 24, a feed pump 22 is provided for pressurizing fuel stored in the fuel tank 23 and feeding it to the delivery pipe 21. The delivery pipe 21 temporarily stores the high pressure fuel pumped from the feed pump 22. If a fuel injector 20 is opened, the high pressure fuel stored in the delivery pipe 21 is directly injected from that fuel injector 20 to the inside of a combustion chamber 11. The delivery pipe 21 is provided with a fuel pressure sensor 211 for detecting the fuel pressure inside the delivery pipe 21, that is, the pressure (injection pressure) of fuel injected from a fuel injector 20 to the inside of the cylinder.

The feed pump 22 is configured to be able to be changed in discharge amount. The discharge amount of the feed pump 22 is changed by a control signal from the electronic control unit 200. By controlling the discharge amount of the feed pump 22, the fuel pressure inside the delivery pipe 21, that is, the injection pressure of each fuel injector 20, is controlled.

The intake system 3 includes a device for guiding intake air to the inside of a combustion chamber 11 and is configured to be able to change the state of the intake air sucked into the combustion chamber 11 (intake pressure, intake temperature, amount of ECR (exhaust gas recirculation) gas). The intake system 3 comprises an intake passage 30, intake manifold 31, and EGR passage 32.

The intake passage 30 is connected at one end to an air cleaner 34 and is connected at the other end to an intake collector 31a of the intake manifold 31. At the intake passage 30, in order from the upstream side, an air flow meter 212, compressor 71 of the exhaust turbocharger 7, intercooler 35, and throttle valve 36 are provided.

The air flow meter 212 detects the flow rate of air flowing through the inside of the intake passage 30 and finally being taken into a cylinder 10.

The compressor 71 comprises a compressor housing 71a and a compressor wheel 71b arranged inside the compressor housing 71a . The compressor wheel 71b is driven to rotate by a turbine wheel 72b of the exhaust turbocharger 7 attached on the same shaft and compresses and discharges intake air flowing into the compressor housing 71a . At the turbine 72 of the exhaust turbocharger 7, a variable nozzle 72c for controlling the rotational speed of the turbine wheel 72b is provided. By using the variable nozzle 72c to control the rotational speed of the turbine wheel 72b , the pressure of the intake air discharged from inside the compressor housing 71a (supercharging pressure) is controlled.

The intercooler 35 is a heat exchanger for cooling the intake air compressed by the compressor 71 and becoming a high temperature by, for example, running air or cooling water.

The throttle valve 36 changes the passage cross-sectional area of the intake passage 30 to adjust the amount of intake air introduced into the intake manifold 31. The throttle valve 36 is driven to operate by a throttle actuator 36a. The throttle sensor 213 detects its opening degree (throttle opening degree).

The intake manifold 31 is connected to an intake port 14 formed in the engine body 1. The intake air flowing in from the intake passage 30 is evenly distributed to the cylinders 10 through the intake port 14. The intake collector 31a of the intake manifold 31 is provided with an intake pressure sensor 214 for detecting the pressure of the intake air sucked into the cylinders (intake pressure) and an intake temperature sensor 215 for detecting the temperature of the intake air sucked into the cylinders (intake temperature).

The EGR passage 32 is a passage for connecting the exhaust manifold 41 and intake collector 31a of the intake manifold 31 and returning part of the exhaust discharged from each cylinder 10 to the intake collector 31a by the pressure difference. Below, the exhaust flowing into the EGR passage 32 will be called the “EGR gas”. By making the EGR gas recirculate to the intake collector 31a and in turn the individual cylinders 10, it is possible to reduce the combustion temperature and keep down the discharge of nitrogen oxides (NO_{z}). In the FGR passage 32, in order from the upstream side, an EGR cooler 37 and EGR valve 38 are provided.

The EGR cooler 37 is a heat exchanger for cooling the EGR gas by, for example, running air or cooling water.

The EGR valve 38 is a solenoid valve enabling continuous or stepwise adjustment of the opening degree. The opening degree is controlled by the electronic control unit 200 in accordance with the engine operating state. By controlling the opening degree of the EGR valve 38, the flow rate of the EGR gas recirculated to the intake collector 31a is adjusted.

The exhaust system 4 includes a device for discharging exhaust from the cylinders and is comprised of an exhaust manifold 41 and exhaust passage 42.

The exhaust manifold 41 is connected to an exhaust port 15 formed at the engine body 1 and gathers together the exhaust discharged from the cylinders 10 for introduction into the exhaust passage 42.

In the exhaust passage 42, in order from the upstream side, the turbine 72 of the exhaust turbocharger 7 and an exhaust post-treatment device 43 are provided.

The turbine 72 is provided with a turbine housing 72a and a turbine wheel 72b arranged inside the turbine housing 72a . The turbine wheel 72b is driven to rotate by the energy of the exhaust flowing into the turbine housing 72a and drives a compressor wheel 71b attached on the same shaft.

At the outside of the turbine wheel 72b , the above-mentioned variable nozzle 72c is provided. The variable nozzle 72c functions as a throttle valve. The nozzle opening degree (valve opening degree) of the variable nozzle 72c is controlled by the electronic control unit 200. By changing the nozzle opening degree of the variable nozzle 72c , it is possible to change the flow rate of exhaust driving the turbine wheel 72b inside the turbine housing 72a . That is, by changing the nozzle opening degree of the variable nozzle 72c , it is possible to change the rotational speed of the turbine wheel 72b to change the supercharging pressure. Specifically, if reducing the nozzle opening degree of the variable nozzle 72c (throttling the variable nozzle 72c ), the flow rate of the exhaust rises, the rotational speed of the turbine wheel 72b increases, and the supercharging pressure increases.

The exhaust post treatment device 43 is a device for cleaning the exhaust, then discharging it into the outside air and is provided with various types of exhaust purification catalysts for removing harmful substances, filters for trapping harmful substances, etc.

The intake valve operating system 5 includes a device for driving operation of the intake valve 50 of each cylinder 10 and is provided at the engine body 1. The intake valve operating system 5 according to the present embodiment is configured to for example drive operation of the intake valve 50 by an electromagnetic actuator so as to enable control of the operating timing of the intake valve 50 to any timing. However, the device is not limited to this. It is also possible to configure it to drive operation of the intake valve 50 by the intake camshaft and provide a variable valve operating mechanism at one end part of the intake camshaft to control the oil pressure and thereby change the relative phase angle of the intake camshaft with respect to the crankshaft and enable the operating timing of the intake valve 50 to be controlled to any timing.

The exhaust valve operating system 6 includes a device for driving operation of the exhaust valve 60 of each cylinder 10 and is provided at the engine body 1. The exhaust valve operating system 6 according to the present embodiment is configured so as to make the exhaust valve 60 of the each cylinder 10 open during the exhaust stroke and to enable opening even during the intake stroke in accordance with need. In the present embodiment, an electromagnetic actuator controlled by the electronic control unit 200 is employed in the exhaust valve operating system 6. By driving operation of the exhaust valve 60 of each cylinder 10 by an electromagnetic actuator, the operating timing and lift of the exhaust valve 60 are controlled to any timing and lift. Note that, the exhaust valve operating system 6 is not limited to an electromagnetic actuator. For example, it is also possible to employ a valve operating device changing the operating time or lift of an exhaust valve 60 by changing the cam profile by oil pressure etc.

As shown in FIG. 2, the ozone supply system 8 is provided with an ozone generator 81, ozone injector 82, and-ozone supply pipe 83.

The ozone generator 81 is a device for generating ozone from the oxygen in the air. In the present embodiment, it generates ozone by discharge (silent discharge, corona discharge, streamer discharge, etc.), but it may also generate it by ultraviolet light, electrolysis, etc. Discharge by the ozone generator 81 is performed by a control signal from the electronic control unit 200.

The ozone injector 82 is attached to the intake manifold 31 and injects ozone into the intake manifold 31 to supply ozone to the combustion chamber 11 of each cylinder 10. The opening time (injection amount) and opening timing (injection timing) of the ozone injector 82 are changed by control signals from the electronic control unit 200. If the ozone injector 82 is opened, ozone is injected into the intake manifold 31. Note that the ozone injector 82 can also be attached to the engine body 1 so as to be able to directly inject ozone into the combustion chamber 11 of each cylinder 10.

The ozone supply pipe 83 is connected at one end to the ozone generator 81 and is connected at the other end to the ozone injector 82.

The electronic control unit 200 is comprised of a digital computer provided with components connected with each other by a bidirectional bus 201 such as a ROM (read only memory) 202, RAM (random access memory) 203, CPU (microprocessor) 204, input port 205, and output port 206.

The input port 205 receives as input the output signals of the above-mentioned fuel pressure sensor 211 etc, through the corresponding AD converters 207. Further, the input port 205 receives as input, as a signal for detecting the engine load, the output voltage of a load sensor 217 generating an output voltage proportional to the amount of depression of the accelerator pedal 220 (below, referred to as “the amount of accelerator depression”) through the corresponding AD converter 207. Further, the input port 205 receives as input, as a signal for calculating the engine rotational speed etc., the output signal of a crank angle sensor 218 generating an output pulse each time the crankshaft of the engine body 1 rotates for example by 15°. In this way, the input port 205 receives as input the output signals of various types of sensors required for control of the internal combustion engine 100.

The output port 206 is connected to the fuel injectors 20 and other controlled parts through the corresponding drive circuits 208.

The electronic control unit 200 outputs control signals for controlling the various controlled parts from the output port 206 to control the internal combustion engine 100 based on the output signals of the various types of sensors input to the input port 205. Below, the control of the internal combustion engine 100 performed by the electronic control unit 200 will be explained.

The electronic control unit 200 switches the operating mode of the engine body 1 to either a spark ignition operating mode (below, referred to as the “SI operating mode”) or a compression ignition operating mode (below, referred to as the “CI operating mode”) based on the engine operating state (engine rotational speed and engine load).

Specifically, the electronic control unit 200 switches the operating mode to the CI operating mode if the engine operating state is in the self-ignition region RR surrounded by the solid line in FIG. 3 and switches the operating mode to the SI operating mode if it is in a region other than the self-ignition region RR. Further, the electronic control unit 200 controls combustion in accordance with the operating mode.

When the operating mode is the SI operating mode, the electronic control unit 200 basically forms premixed gas of the stoichiometric air-fuel ratio or near the stoichiometric air-fuel ratio for ignition in the combustion chamber 11 by the spark plug 16 and burns that premixed gas by the flame-propagation combustion to operate the engine body 1.

Further, when the operating mode is the CI operating mode, the electronic control unit 200 basically forms premixed gas of an air-fuel ratio leaner than the stoichiometric air-fuel ratio in the combustion chamber 11 (for example 30 to 40 or so) and burns that premixed gas by the compression-ignition combustion to operate the engine body 1. In the present embodiment, as the premixed gas, stratified premixed gas having a burnable layer at the center part of the inside of the combustion chamber 11 and having an air layer around the inside wall surface of the cylinder is formed. Note that as explained later, in the present embodiment, when making the premixed gas burn in the combustion chamber 11 by the compression-ignition combustion, part of the fuel is made to burn by the flame-propagation combustion and the heat generated at that time is used to make the remaining fuel burn by the premixing- and compression-ignition combustion as an “ignition-assist self-ignition combustion”.

The fuel may be burned by the premixing- and compression-ignition combustion by making the air-fuel ratio leaner compared with the flame-propagation combustion and, further, by making the compression ratio higher. For this reason, by burning the fuel by the premixing- and compression-ignition combustion, it is possible to improve the fuel economy and possible to improve the heat efficiency. Further, the premixing- and compression-ignition combustion has a lower combustion temperature compared with the flame-propagation combustion, so it is possible to suppress the generation of NOₓ. Further, there is sufficient oxygen around the fuel, so it is possible to suppress generation of unburned HC.

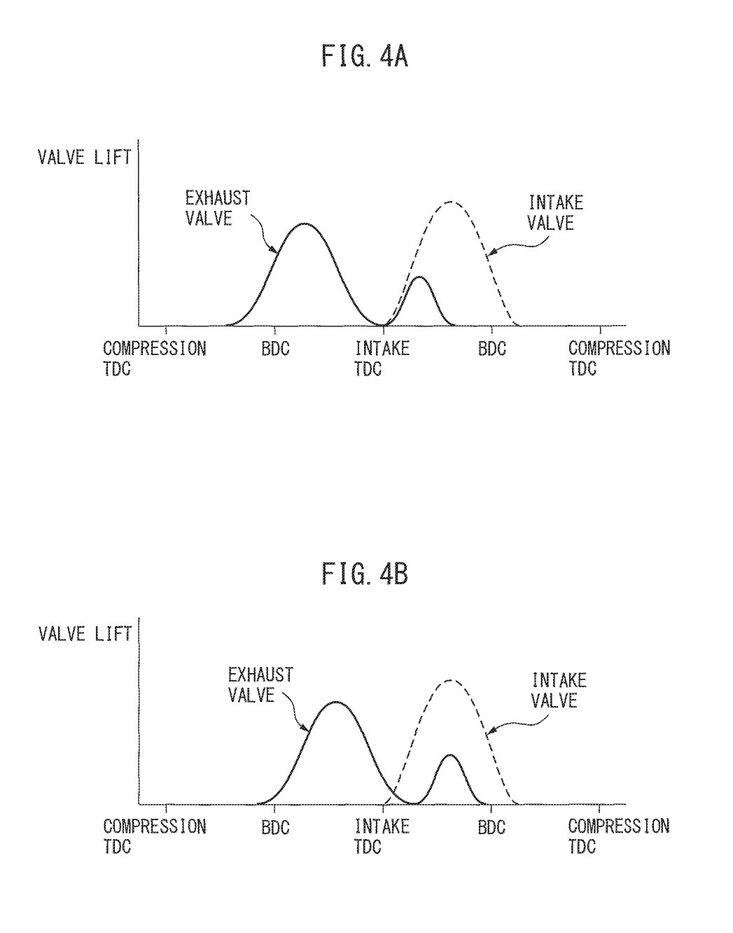

Note that in burning fuel by the premixing- and compression-ignition combustion, it is necessary to make the cylinder temperature rise up to the temperature enabling self-ignition of the premixed gas and necessary to make the cylinder temperature higher than when making all of the premixed gas burn by the flame-propagation combustion in the combustion chamber 11 like in the SI operating mode. For this reason, in the present embodiment, for example, as shown in FIG. 4A and FIG. 4B, during the CI operating mode, the exhaust valve operating system 6 is controlled so that the exhaust valve 60 opens not only in the exhaust stroke, but also the suction stroke. By performing an exhaust valve double-opening operation opening the exhaust valve 60 again during the suction stroke in this way, it is possible to make the high temperature exhaust exhausted from a cylinder during an exhaust stroke be sucked back into the same cylinder during the immediately succeeding suction stroke. Due to this, the cylinder temperature is made to rise and the cylinder temperature of each cylinder 10 is maintained at a temperature enabling fuel to be burned by the premixing- and compression-ignition combustion.

As shown in FIG. 4A, if opening the exhaust valve 60 when the amount of lift of the intake valve 50 is small, it is possible to make a large amount of exhaust be sucked back into the same cylinder, so it is possible to make the cylinder temperature greatly rise. On the other hand, as shown in FIG. 4B, if opening the exhaust valve 60 right after the amount of lift of the intake valve 50 increases by a certain extent, the exhaust is sucked back after a certain extent of air (fresh air) is sucked into a cylinder, so it is possible to keep down the amount of exhaust sucked back into the same cylinder and keep down the amount of rise of the cylinder temperature. In this way, it is possible to control the amount of rise of the cylinder temperature in accordance with the timing of performing the exhaust valve double-opening operation. In the present embodiment, the ratio of the amount of EGR gas in the amount of gas in the cylinder and the amount of exhaust sucked back into the same cylinder wall be called the “EGR rate”.

When making the premixed gas burn by the compression-ignition combustion, the fuel dispersed inside the combustion chamber 11 self-ignites at multiple points at the same timing. For this reason, the greater the amount of fuel consumed in the compression-ignition combustion, the greater the combustion noise [dB]. There is the problem that the combustion noise becomes greater than even when burning the premixed gas by the flame-propagation combustion.

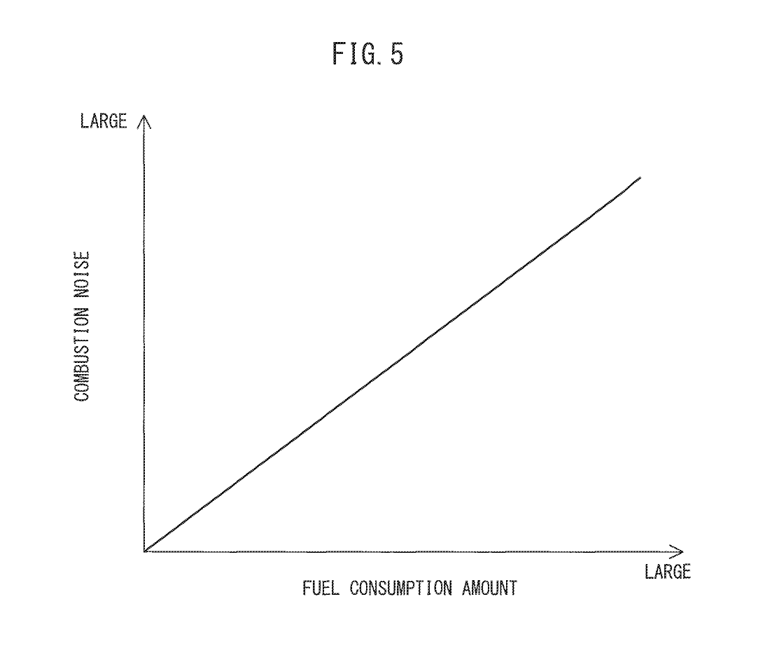

FIG. 5 is a view showing the relationship between the amount of fuel consumed by the compression-ignition combustion and combustion noise when burning premixed gas by the compression-ignition combustion.

As shown in FIG. 5, when burning premixed gas by the compression-ignition combustion, it is learned that the combustion noise increases the greater the amount of fuel consumed by compression-ignition combustion.

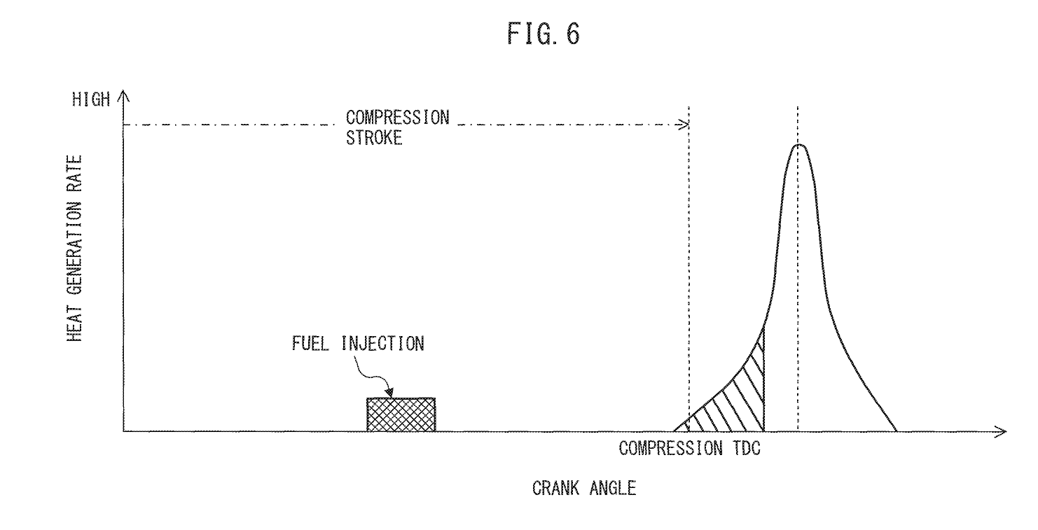

FIG. 6 is a view showing the relationship between the crank angle and heat generation rate when injecting from the fuel injector 20 a predetermined amount of fuel corresponding to the engine load just once at any timing from the suction stroke to the compression stroke (in the example of FIG. 5, −50 deg. ATDC) to burn the fuel by the compression-ignition combustion. The heat generation rate (dQ/dθ) (J/deg. CA) is the amount of heat per unit crank angle generated due to combustion of the premixed gas, that is, the amount of generation of heat Q per unit crank angle. Note that in the following explanation, the waveform of combustion showing the relationship between the crank angle and the heat generation rate will if necessary be called the “heat generation rate pattern”.

As explained above, when making the premixed gas burn by the compression-ignition combustion, the fuel dispersed inside the combustion chamber 11 self-ignites at multiple points at the same timing, so the speed of combustion becomes faster and the combustion period becomes shorter than the flame-propagation combustion. For this reason, as shown in FIG. 6, when making the premixed gas burn by the compression-ignition combustion, the peak value of the heat generation rate pattern and the slant (d²Q/(dθ)²) at the initial stage of combustion of the heat generation rate pattern (region shown by the hatching in FIG. 6) tend to become relatively large.

The combustion noise is correlated with the peak value and the slant at the initial stage of combustion of the heat generation rate pattern. The larger the peak value of the heat generation rate pattern and, further, the larger the slant at the initial stage of combustion, the larger the noise. For this reason, when making the premixed gas burn by the compression-ignition combustion, the combustion noise increases compared with when making the premixed gas burn by the flame-propagation combustion.

As the method of reducing the peak value and the slant at the initial stage of combustion of the heat generation rate pattern to reduce the combustion noise, there is the method of assisting ignition by the spark plug 16 to make part of the fuel burn by the flame-propagation combustion and use the heat generated at that time to forcibly raise the cylinder temperature and make the remaining fuel burn by the premixing- and compression-ignition combustion in the ignition-assist self-ignition combustion. By making part of the fuel burn by the flame-propagation combustion in this way, it is possible to limit the amount of fuel consumed by combustion by the premixing- and compression-ignition combustion. For this reason, it is possible to lower the combustion noise compared with making all of the fuel burn by the premixing- and compression-ignition combustion.

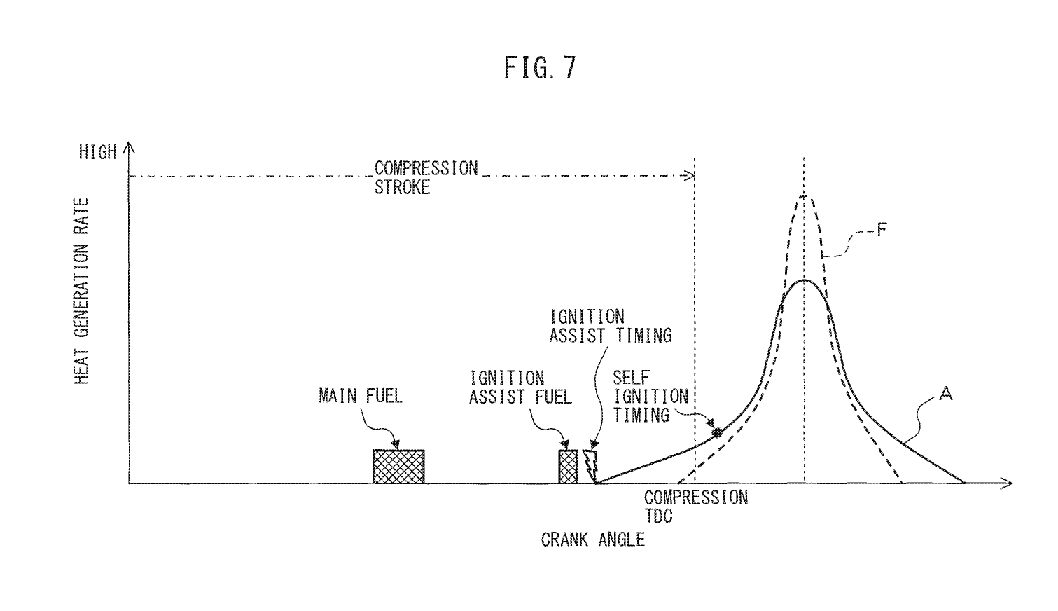

FIG. 7 is a view showing the relationship between the crank angle and heat generation rate when burning fuel by the ignition-assist self-ignition combustion without changing the total amount of fuel injected from the fuel injector 20. In FIG. 7, the heat generation rate pattern A shown by the solid line is the heat generation rate pattern when burning fuel by the ignition-assist self-ignition combustion so as to burn premixed gas by the compression-ignition combustion. The heat generation rate pattern F shown by the broken line is the heat generation rate pattern of FIG. 6 shown for comparison.

As shown in FIG. 7, when assisting ignition to burn premixed gas by the compression-ignition combustion, first main fuel and ignition assist fuel are successively injected from the fuel injector 20. Further, the main fuel is injected at any timing from the suction stroke to the compression stroke (in the example of FIG. 7, the latter half of the compression stroke) to form a premixed gas inside the combustion chamber. Further, the ignition assist fuel is injected at any timing in the second half of the compression stroke after injecting the main fuel to form a rich air-fuel mixture of an air-fuel ratio richer than this premixed gas around the spark plug.

Next, at any timing in the second half of the compression stroke after injecting the ignition assist fuel (ignition assist timing shown in FIG. 7), this rich air-fuel mixture is ignited by the spark plug 16 (ignition assist) to make mainly this rich air-fuel mixture burn by the flame-propagation combustion and the heat generated at this time is used to forcibly make the cylinder temperature rise to make the premixed gas burn by the compression-ignition combustion.

When assisting ignition, in the period from ignition assist timing to self-ignition timing, mainly the rich air-fuel mixture is burned by the flame-propagation combustion. For this reason, as shown in FIG. 7, the slant at the initial stage of combust ion of the heat generation rate pattern A in the case of assisting ignition becomes smaller than the slant at the initial stage of combustion of the heat generation rate pattern

Further, at the self-ignition timing, the premixed gas is burned by the compression-ignition combustion, but part of the fuel is already consumed by the flame-propagation combustion, so the amount of fuel consumed by the premixing- and compression-ignition combustion is relatively decreased. For this reason, as shown in FIG. 7, the peak value of the heat generation rate pattern A when assisting ignition also becomes smaller than the peak value of the heat generation rate pattern F.

In this regard, if burning fuel by the ignition-assist self-ignition combustion, the target values of the amount of injection of ignition assist fuel, injection timing, and ignition assist timing are set in accordance with the engine operating state and the fuel injector 20 and spark plug 16 are controlled in accordance with the target values.

Further, these target values are set in advance by experiments etc. so that the heat generation rate pattern when burning fuel by the ignition-assist self-ignition combustion becomes the heat generation rate pattern of the best heat efficiency and exhaust emission of the engine body 1 (below, referred to as the “target heat generation rate pattern”) in the heat generation rate patterns able to suppress the combustion noise to a predetermined allowable noise value or less.

On the other hand, during engine operation, for example, the intake temperature or intake pressure (supercharging pressure), intake valve closing timing, EGR rate, engine cooling water temperature, and other parameters having an effect on the compression-ignition combustion are controlled by target values corresponding to the engine operating state. For this reason, the target values of the amount of injection of ignition assist fuel, injection timing, and ignition assist timing set in advance by experiments etc. so that the heat generation rate pattern becomes the target generation rate pattern are set in the state where the above other parameters are controlled to target values corresponding to the engine operating states (below, referred to as the “steady state”).

Therefore, even if controlling the amount of injection, injection timing, and ignition assist timing of ignition assist fuel respectively to the target values corresponding to the engine operating state, when the above-mentioned other parameters are transitionally not being controlled to the target values corresponding to the engine operating states (below, referred to as the “transition state”), the heat generation rate pattern when burning fuel by an ignition-assist self-ignition combustion is liable to change. As a result, at the time of the transition state, it is not possible to make the heat generation rate pattern the target heat generation rate pattern and the combustion noise and heat efficiency of the engine body 1, exhaust emission, etc. are liable to deteriorate.

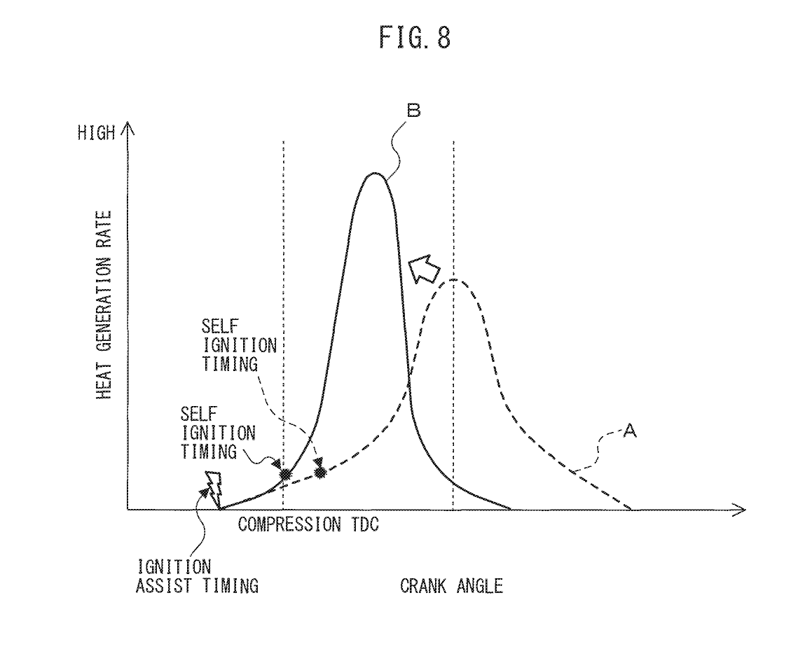

FIG. 8 is a view explaining, as one example of a transition state, changes in the heat generation rate pattern when burning fuel in an ignition-assist self-ignition combustion in the case where the intake temperature becomes a higher temperature than the target value. In FIG, 8, the heat generation rate pattern B shown by the solid line is the heat generation rate pattern when the intake temperature is a higher temperature than the target value. The heat generation rate pattern A shown by the broken line is the same as the heat generation rate pattern A of FIG. 7. This heat generation rate pattern A is the heat generation rate pattern when burning fuel by the ignition-assist self-ignition combustion in the steady state and corresponds to the target heat generation rate pattern.

When the intake temperature is a higher temperature than the target value, the cylinder temperature becomes higher compared with when the intake temperature is controlled to the target value at the same crank angle. For this reason, as shown in FIG. 8, even if the ignition assist timing is the same, compared with when the intake temperature is controlled to the target value, the self-ignition timing advances. This being so, the amount of fuel consumed by the flame-propagation combustion is reduced over the one predicted, while the amount of fuel consumed by combustion by the premixing- and compression-ignition combustion is increased over the one predicted.

Therefore, as shown in FIG, 8, the peak value and the slant at the initial stage of combustion of the heat generation rate pattern B become greater than the target heat generation rate pattern (heat generation rate pattern A) and the combustion noise increases. In this way, even if burning fuel by the ignition-assist self-ignition combustion, if the self-ignition timing ends up becoming advanced from the predicted one in the transition state, the combustion noise is liable to increase and become greater than the allowable noise value. Further, by the self-ignition timing becoming more advanced than predicted, the heat generation rate pattern changes and becomes a heat generation rate pattern different from the target generation rate pattern, so the heat efficiency and the exhaust emission of the engine body 1 are liable to deteriorate,

Note that if the intake pressure is a higher pressure than the target value, if the intake valve closing timing becomes advanced or retarded from the target value and thereby the actual compression ratio becomes higher etc., the cylinder temperature becomes higher compared to when these are controlled to the target values at the same crank angle. For this reason, even in these cases, the same phenomenon occurs resulting in the increase of combustion noise and the heat efficiency and exhaust emission of the engine body 1 are also liable to deteriorate.

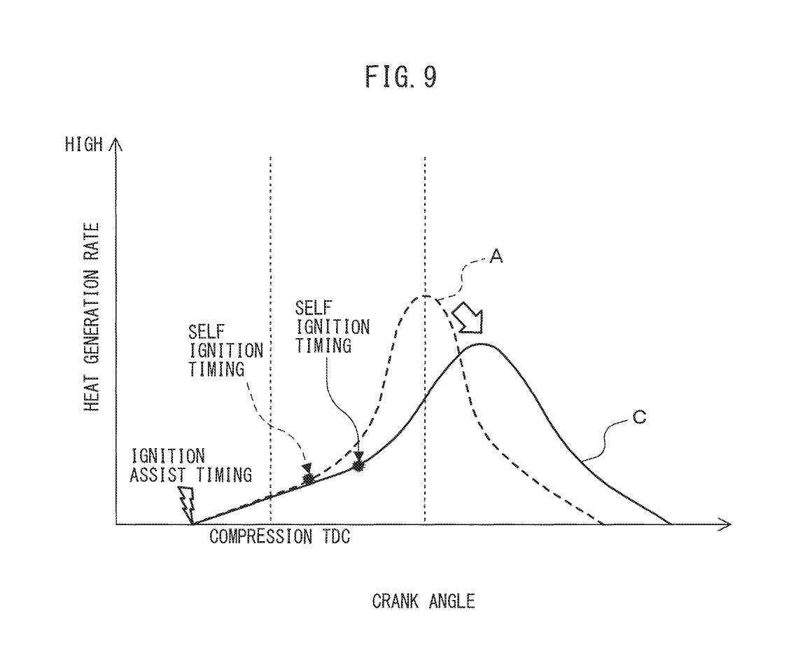

FIG. 9 is a view for explaining the changes in the heat generation rate pattern when burning fuel by an ignition-assist self-ignition combustion in the case where, as one example of the transition state, the intake temperature becomes a lower temperature than the target value. In FIG, 9, the heat generation rate pattern C shown by the solid line is a heat generation rate pattern in the case where the intake temperature becomes a lower temperature than the target value. The heat generation rate pattern. A shown by the broken line is the same as the heat generation rate pattern A of FIG. 7 and corresponds to the target heat generation rate pattern.

If the intake temperature becomes a lower temperature than the target value, the cylinder temperature becomes lower compared with when the intake temperature is controlled to the target value at the same crank angle. For this reason, as shown in FIG. 9, even if the ignition assist timing is the same, the self-ignition timing becomes retarded compared with when the intake temperature is controlled to the target value. As a result, the amount of fuel consumed by the flame-propagation combustion ends up increasing over that predicted while the amount of fuel consumed by the premixing- and compression-ignition combustion ends up decreasing over that predicted. In this case, the combustion noise never increases, but the self-ignition timing is retarded from that predicted and thereby the heat generation rate pattern changes and becomes a heat generation rate pattern different from the target generation rate pattern, so the heat efficiency and exhaust emission of the engine body 1 are liable to deteriorate.

In this way, in the transition state, the combustion noise is liable to increase compared with the steady state. Further, the heat efficiency and exhaust emission of the engine body 1 are liable to deteriorate. Note that, in the following explanation, when it is necessary to particularly differentiate the transition states, as explained referring to FIG. 8, the transition state where the combustion noise deteriorates from the steady state will be referred to as the “first transition state (noise transition state)”. On the other hand, as explained referring to FIG. 9, the transition state where the combustion noise itself does not deteriorate from the steady state will be referred to as the “second transition state”.

Here, as the method for dealing with a change in the heat generation rate pattern when the state becomes a transition state and the self-ignition timing becomes advanced or retarded from that predicted, the method of advancing or retarding the injection timing and ignition assist timing of the ignition assist fuel so as to retard or advance the self-ignition timing may be considered.

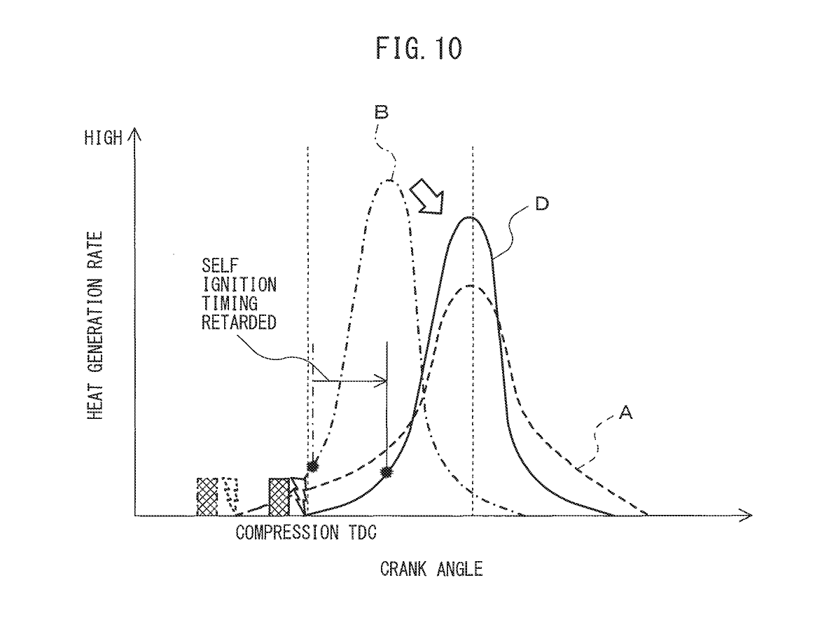

According to this method, changes in the heat generation rate pattern can be suppressed to a certain extent. However, the combustion noise when the state becomes the first transition state sometimes cannot be sufficiently suppressed. Below, this point will be explained while referring to FIG. 10.

FIG. 10 is a view for explaining the changes in the heat generation rate pattern when retarding the injection timing and ignition assist timing of the ignition assist fuel to thereby retard the self-ignition timing in the case where the state becomes the first transition state. In. FIG. 10, the heat generation rate pattern D shown by the solid line is a heat generation rate pattern when retarding the self-ignition timing in the case where the state becomes the first transition state. The heat generation rate pattern A shown by the broken line is the same as the heat generation rate pattern. A of FIG. 7 and corresponds to the target heat generation rate pattern. The heat generation rate pattern B shown by the one-dot chain line is the same as the heat generation rate pattern B of FIG. 8 and corresponds to the heat generation rate pattern when not retarding the self-ignition timing in the case where the state becomes the first transition state.

As shown in FIG. 10, when the state becomes tree first transition state, by retarding the injection timing and ignition assist timing of the ignition assist fuel to retard the self-ignition timing, it is possible to make the center of gravity position of combustion of the heat generation rate pattern D in the first transition state (position where ratio of combustion of fuel becomes 50% and where heat generation rate becomes substantially the peak value) approach the center of gravity position of combustion of the target heat generation rate pattern A. For this reason, it is possible to make the heat generation rate pattern D approach the target heat generation rate pattern A to a certain extent. However, since the ignition assist timing is retarded, the cylinder temperature at the ignition assist timing relatively rises. For this reason, in the end, the period from the ignition assist timing to the self-ignition timing ends up becoming shorter and the amount of fuel consumed by the flame-propagation combustion is reduced by that amount. Therefore, as shown in FIG. 10, the peak value and the slant at the initial stage of combustion of the heat generation rate pattern D end up becoming larger compared with the target heat generation rate pattern A and deterioration of the combustion noise cannot be sufficiently suppressed.

Therefore, in the present embodiment, the amount of supply of ozone to the inside of the combustion chamber 11 was controlled to suppress changes in the heat generation rate pattern when the state becomes the transition state and in particular to suppress the deterioration of combustion noise when the state becomes the first transition state.

The ozone supplied to the inside of the combustion chamber 11 breaks down and produces oxygen radicals, one type of active species, if the temperature inside the combustion chamber 11 rises from a predetermined temperature (for example 500K to 600K or so). It is known that oxygen radicals act on fuel molecules and thereby raise the self-ignitability of fuel. The greater the amount of oxygen radicals present in the combustion chamber 11, the earlier the self-ignition timing of the premixed gas. That is, the more the amount of supply of ozone is increased, the earlier the self-ignition timing of the premixed gas can be made. For this reason, when making the premixed gas burn by the compression-ignition combustion, the waveform of combustion (shape of heat generation rate pattern) changes in accordance with the amount of oxygen radicals in the combustion chamber 11.

On the other hand, the oxygen radicals have almost no effect on the speed of combustion of the flame-propagation combustion when making fuel burn by the flame-propagation combustion. For this reason, regardless of the presence or absence of oxygen radicals and amount of the same, the waveform of combustion during the flame-propagation combustion (shape of heat generation rate pattern) does not change much at all.

Therefore, if trying to burn fuel by the ignition-assist self-ignition combustion in a state supplying a predetermined reference amount of ozone into a combustion chamber 11, by changing the amount of supply of ozone when the state is a transition state, it is possible to change just the self-ignition timing without changing the waveform of combustion during the flame-propagation combustion (shape of heat generation rate pattern).

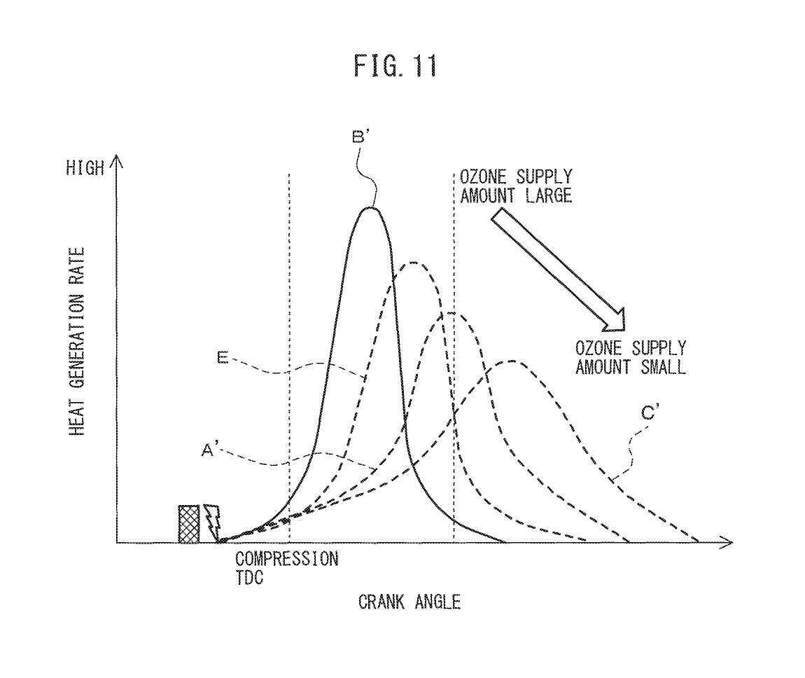

FIG. 11 is a view explaining the changes of the heat generation rate pattern due to differences in the amount of supply of ozone to the inside of the combustion chamber 11 when burning fuel by the ignition-assist self-ignition combustion in the case the state becomes the first transition state.

In FIG. 11, the heat generation rate pattern B′ is a heat generation rate pattern of the same shape of the heat generation rate pattern B of FIG. 8 and a heat generation pattern when burning fuel by the ignition-assist self-ignition combustion in the state controlling the amount of supply of ozone to the inside of the combustion chamber 11 to the reference amount in the case where the state becomes the first transition state.

The heat generation rate patterns E, A′, and C′ are respectively the heat generation patterns when burning fuel by the ignition-assist self-ignition combustion in the state of reducing the amount of supply of ozone to the inside of the combustion chamber 11 from the reference amount in the case where the state becomes the first transition state. The amount of supply of ozone to the inside of the combustion chamber 11 is reduced from the reference amount in the order of the heat generation rate patterns F, A′, and C′. Note that the heat generation rate pattern A′ is a heat generation rate pattern of the same shape as the heat generation rate pattern A of FIG. 7 and corresponds to the target heat generation rate pattern. The heat generation rate pattern C′ is a heat generation rate pattern of the same shape as the heat generation rate pattern C of FIG. 9.

In this way, if trying to burn fuel by the ignition-assist self-ignition combustion in the state of supplying a predetermined reference amount of ozone to the inside of the combustion chamber 11, by making the amount of supply of ozone smaller than the reference amount when the state becomes the first transition state, it is possible to retard just the self-ignition timing without changing the waveform of combustion during the flame-propagation combustion (shape of heat generation rate pattern). For this reason, as shown in FIG. 11, by Suitably controlling the amount of supply of ozone, it is possible to make the heat generation rate pattern at the first transition state the target heat generation rate pattern.

Below, the combustion control during the CI operating mode according to this embodiment will be explained.

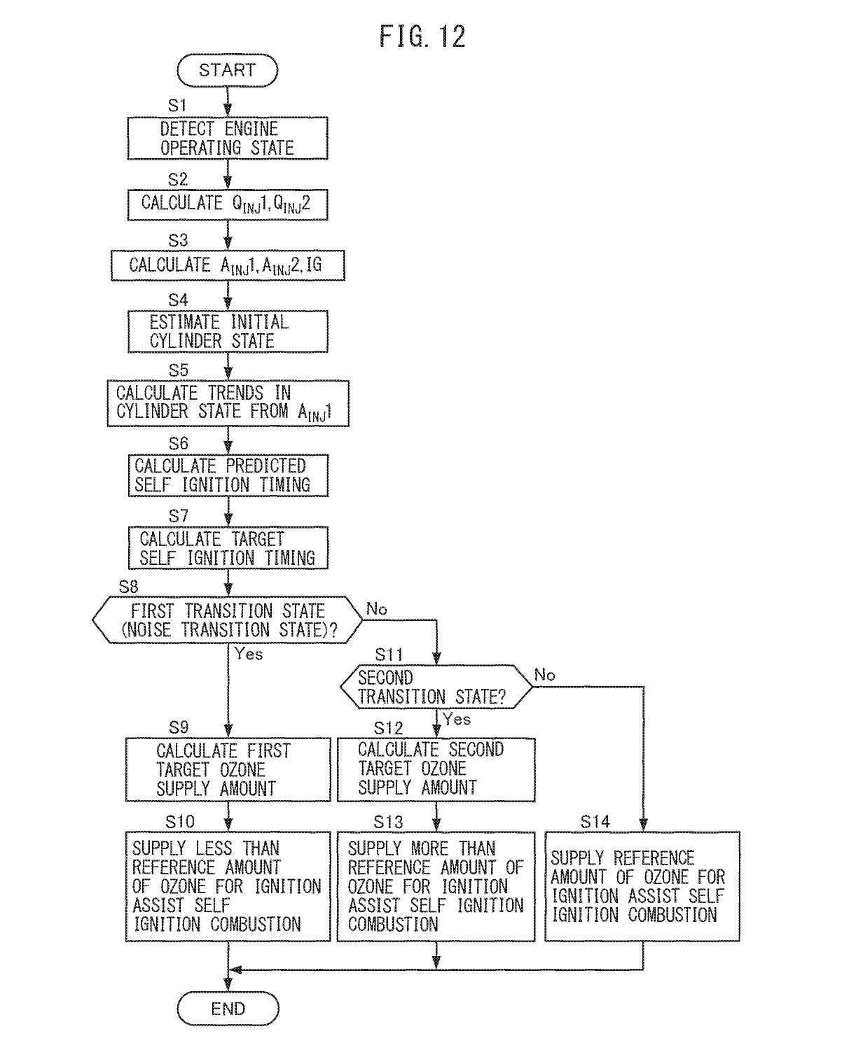

FIG. 12 is a flow chart explaining the combustion control during the CI operating mode according to the present embodiment. The electronic control unit 200 repeatedly performs this routine by a predetermined processing period (for example, 10 ms) during the CI operating mode.

At step S1, the electronic control unit 200 reads the engine rotational speed calculated based on the output signal of the crank angle sensor 218 and the engine load detected by the load sensor 217 and detects the engine operating state.

At step S2, the electronic control unit 200 refers to the table prepared in advance by experiments etc. and calculates the target injection amount Q_{INJ}1 of the main fuel and the target injection amount Q_{INJ}2 of the ignition assist fuel based on the engine load. The total fuel injection amount Q_{INJ} obtained by adding the target injection amount Q_{INJ}1 of the main fuel and the target injection amount Q_{INJ}2 of the ignition assist fuel becomes greater the higher the engine load.

At step S3, the electronic control unit 200 refers to the map prepared in advance by experiments etc. and calculates the target injection timing A_{INJ}1 of the main fuel, the target injection timing A_{INJ}2 of the ignition assist fuel, and the target ignition assist timing IG by the spark plug 16 based on the engine operating state.

In the present embodiment, the target injection timing A_{INJ}1 of the main fuel is set to any timing in the second half of the compression stroke (for example 30 deg. BTDC to 80 deg. BTDC) based on the operating state.

Further, in the present embodiment, the target injection timing A_{INJ}2 of the ignition assist fuel is set to any timing in the second half of the compression stroke at the retarded side from the target injection timing A_{INJ}1 of the main fuel (for example 10 deg. BTDC to 35 deg. BTDC) based on the engine operating state.

Further, in the present embodiment, the target ignition assist timing IG is set to any timing at the advanced side or retarded side from the target injection timing A_{INJ}2 of the ignition assist fuel near the target injection timing A_{INJ}2 of the ignition assist fuel (for example, if the target injection timing A_{INJ}2 of the ignition assist fuel is 15 deg. BTDC, 18 deg. BTDC to 10 deg. BTDC) based on the engine operating state.

Note that, in addition to the target values of these target injection timing A_{INJ}1 of the main fuel etc., the electronic control unit 200 calculates separately from this flow chart the target intake temperature and target intake pressure and the target intake valve closing timing and other such target valve timings of the intake and exhaust valves based on the engine operating state and controls the various controlled parts to become the calculated target values.

At step S4, the electronic control unit 200 estimates the cylinder pressure P and cylinder temperature T at the target intake valve closing timing, that is, the initial cylinder state. In the present embodiment, the electronic control unit 200 uses the estimation model of the initial cylinder state to estimate the initial cylinder state. The estimation model of the initial cylinder state is a physical processing model using the intake amount or intake temperature, intake pressure, engine cooling water temperature, and other parameters having an effect on the cylinder state as input values to estimate the cylinder pressure P and cylinder temperature T at the target intake valve closing timing.

At step S5, the electronic control unit 200 calculates the trends in the cylinder pressure P and cylinder temperature T from the target injection timing of the main fuel when burning fuel by the ignition-assist self-ignition combustion.

In the present embodiment, the electronic control unit 200 first uses the trend model of the cylinder state to estimate the trends in the cylinder pressure P and cylinder temperature T from the intake valve closing timing. The trend model of the cylinder state is a physical processing model for estimating how the cylinder state changes from the initial cylinder state. It uses the cylinder pressure P and cylinder temperature T at the target intake valve closing timing as input values to hypothesize polytropic changes in the cylinder pressure P and cylinder temperature T during the compression stroke and to estimate the trends in the cylinder pressure P and cylinder temperature T from the target intake valve closing timing.

Here, if assisting ignition, the trends in the cylinder pressure P and cylinder temperature T from the target ignition assist timing change by exactly the amount of heat generated by the ignition assist operation from the trends in the cylinder pressure P and cylinder temperature T from the intake valve closing timing estimated using the trend model of the cylinder state.

Therefore, the electronic control unit 200 next corrects the trends in the cylinder pressure P and the cylinder temperature T from the target ignition assist timing based on the target injection amount and target injection timing of the ignition assist fuel and the target ignition assist timing by the spark plug 16 and calculates the trends in the cylinder pressure P and the cylinder temperature T from the target injection timing of the main fuel in the case of burning fuel by the ignition-assist self-ignition combustion.

At step S6, the electronic control unit 200 uses the trends in the cylinder pressure P and the cylinder temperature T from the target injection timing of the main fuel in the case of burning fuel by the ignition-assist self-ignition combustion so as to calculate the predicted self-ignition timing (deg. CA) of the premixed gas from the following formula (1) based on the Livengood-Wu integration formula:

$$\int {( \frac{1}{τ} )}_{P , T} dt = {\int }_{0}^{te} A {∅}^{α} {P}^{β} {ON}^{γ} exp ( δ \cdot RES ) exp ( - \frac{E}{RT} ) \qquad ( 1 )$$

The τ of formula (1) is the time until fuel injected into the combustion chamber 11 self-ignites (below, referred to as the “ignition delay time”). P is the cylinder pressure, T is the cylinder temperature, φ is the equivalent ratio, ON is the octane value, RES is the residual gas ratio (EGR rate), E is the activation energy, and R is the general gas constant. A, α, β, γ, δ (A, α, β, δ>0, γ<0) are respectively identification constants.

In the formula (1), when integrating the reciprocal (1/τ) of the ignition delay time from injecting the. fuel over time, the time to where the integral becomes 1 becomes the ignition delay time τ. Therefore, when integrating the reciprocal (1/τ) of the ignition delay time at the cylinder pressure P and cylinder temperature T over time from the injection timing of the main fuel, the timing when adding the amount of crank angle corresponding to the time to where the integral becomes 1 to the injection timing of the main fuel becomes the predicted self-ignition timing of the premixed gas.

At step S7, the electronic control unit 200 refers to the map prepared in advance by experiments etc. and calculates the target self-ignition timing (deg. CA) based on the engine operating state. This target self-ignition timing is the self-ignition timing of the premixed gas when the heat generation rate pattern in the case of supplying a predetermined amount of ozone in advance in the steady state while assisting ignition to burn premixed gas by the compression-ignition combustion becomes the target heat generation rate pattern.

At step S8, the electronic control unit 200 judges if the combustion noise is in a first transition state increasing from the allowable noise value (noise transition state) when burning fuel by the ignition-assist self-ignition combustion. Specifically, the electronic control unit 200 judges if the amount of deviation Tiga of the predicted self-ignition timing to the advanced side from the target self-ignition timing (below, referred to as the “advanced deviation amount”) (=target self-ignition timing-predicted self-ignition timing) is larger than the predetermined first threshold value. The electronic control unit 200 proceeds to the processing of step S9 so as to retard the predicted self-ignition timing to the target self-ignition timing if the advanced deviation amount Tiga is greater than the first threshold value. On the other hand, the electronic control unit 200 proceeds to the processing of step S11 if the advanced deviation amount Tiga is the first threshold value or less.

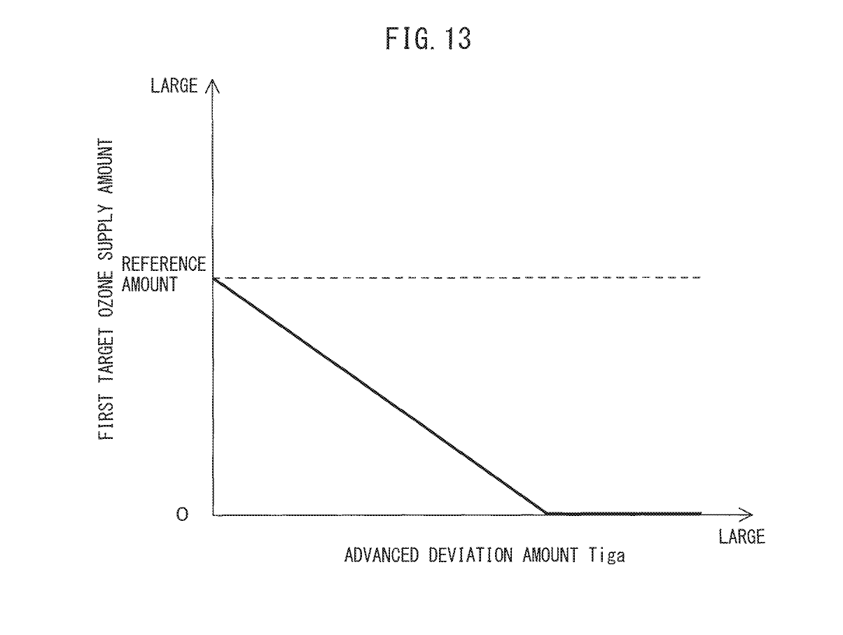

At step S9, the electronic control unit 200 refers to the table shown in FIG. 13 to calculate the target amount of supply of ozone when the state becomes the first transition state based on the advanced deviation amount Tiga (below, referred to as “the first target amount of supply of ozone”). As shown in the table of FIG. 13, the first target amount of supply of ozone becomes smaller than the reference amount (amount of supply of ozone in steady state) the greater the advanced deviation amount Tiga and becomes zero if the advanced deviation amount Tiga becomes a certain constant amount or more. This is because the more the predicted self-ignition timing deviates to the advanced side from the target self-ignition timing, the shorter the period from the ignition assist timing to the self-ignition timing and the greater the combustion noise.

At step S10, the electronic control unit 200 controls the ozone supply system so that the amount of supply of ozone to the inside of the combustion chamber 11 becomes the first target amount of supply of ozone smaller than the reference amount and controls the fuel injector 20 and spark plug 16 in accordance with the target values calculated at step S2 and step S3 to burn fuel by the ignition-assist self-ignition combustion.

At step S11, the electronic control unit 200 judges if the state is the second transition state. Specifically, the electronic control Unit 200 judges if the amount of deviation Tigr of the predicted self-ignition timing to the retarded side from the target self-ignition timing (below, referred to as the “retarded deviation amount”) (=predicted self-ignition timing-target self-ignition timing) is larger than a predetermined second threshold value. In the present embodiment, the first threshold value and the second threshold value are made the same values but they may also be made different values. The electronic control unit 200 proceeds to the processing of step S12 so as to make the predicted self-ignition timing advance to the target self-ignition timing if the retarded deviation amount Tigr is larger than the second threshold value. On the other hand, the electronic control unit 200 proceeds to the processing of step S14 if the retarded deviation amount Tigr is the second threshold value or less.

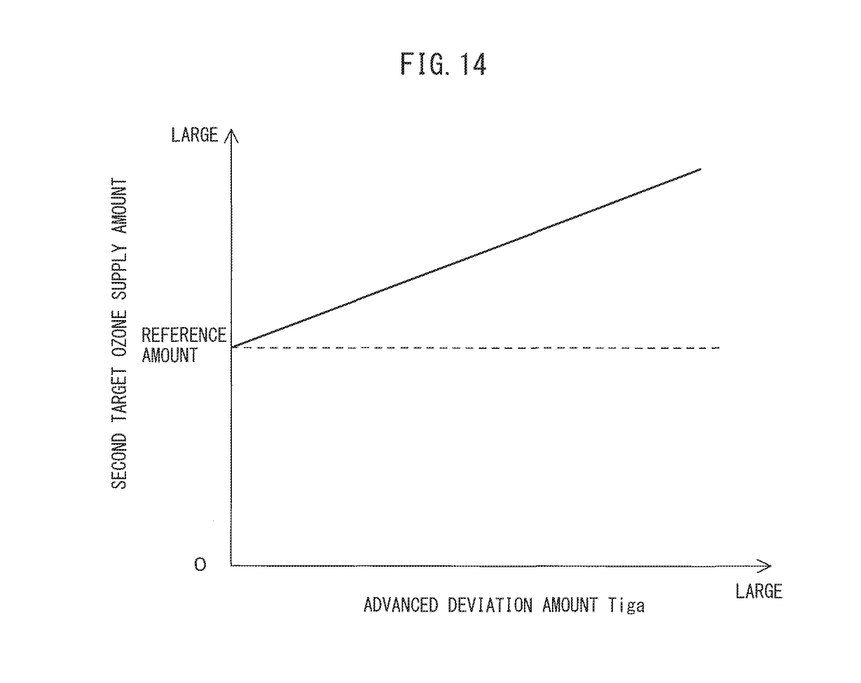

At step S12, the electronic control unit 200 refers to the table shown in FIG. 14 and calculates the target amount of supply of ozone when the state becomes the second transition state (below, referred to as the “second target amount of supply of ozone”) based on the retarded deviation amount Tigr. As shown in the table of FIG. 14, the second target amount of supply of ozone becomes greater than the reference amount (amount of supply of ozone in steady state) the greater the retarded deviation amount Tigr. This is because the more the predicted self-ignition timing deviates to the retarded side from the target self-ignition timing, the shorter the period from the ignition assist timing to the self-ignition timing and the greater the combustion noise.

At step S13, the electronic control unit 200 controls the ozone supply system so that the amount of supply of ozone to the inside of the combustion chamber 11 becomes the second target amount of supply of ozone greater than the reference amount and controls the fuel injector 20 and spark plug 16 in accordance with the target values calculated at step S2 and step S3 to burn fuel by the ignition-assist self-ignition combustion.

At step S14, the electronic control unit 200 controls the ozone supply system so that the amount of supply of ozone to the inside of the combustion chamber 11 becomes the reference amount and controls the fuel injector 20 and spark plug 16 in accordance with the target values calculated at step S2 and step S3 to burn fuel by the ignition-assist self-ignition combustion.

According to the present embodiment explained above, an electronic control unit 200 (control system), for controlling an internal combustion engine 100 provided with an engine body 1, a fuel injector 20 for directly injecting fuel to a combustion chamber 11 of the engine body 1, a spark plug 16 disposed facing the inside of the combustion chamber 11, and an ozone supply system 8 for directly or indirectly supplying ozone to the combustion chamber 11, is configured comprising a combustion control part controlling an injection amount and injection timing of a fuel injector 20 and an ignition timing of the spark plug 16 so as to make part of the fuel burn by the flame-propagation combustion by a spark plug 16 and use the heat generated at that time to make the remaining fuel burn by the premixing- and compression-ignition combustion as an ignition-assist self-ignition combustion inside the combustion chamber 11, an operating state judging part judging whether the engine operating state is the steady state or a first transition state (noise transition state) where the combustion noise becomes greater than a predetermined allowable noise value when burning fuel by an ignition-assist self-ignition combustion, and an ozone supply control part controlling the amount of supply of ozone by the ozone supply system 8.

Further, the ozone supply control part is configured to control the amount of supply of ozone to a predetermined reference amount when it is judged the state is the steady state and to control the amount of supply of ozone to an amount of supply smaller than the reference amount or makes the amount of supply of ozone zero when it is judged the state is the first transition state.

In this way, if trying to supply the reference amount of ozone and burn fuel by the ignition-assist self-ignition combustion when the state is the steady state, by controlling the amount of supply of ozone to an amount of supply smaller than the reference amount or making the amount of supply of ozone zero when the state is the first transition state, it is possible to retard just the self-ignition timing without changing the combustion waveform during the flame-propagation combustion (shape of heat generation rate pattern).

For this reason, in the first transition state where the self-ignition timing ends up becoming advanced more than predicted when burning fuel by the ignition-assist self-ignition combustion, it is possible to retard just the self-ignition timing without changing the combustion waveform during the flame-propagation combustion (shape of heat generation rate pattern). For this reason, it is possible to suppress an increase in the amount of fuel consumed by the premixing- and compression-ignition combustion, so it is possible to suppress deterioration of the combustion noise in the first transition state. Further, due to this, the deviation of the heat generation rate pattern from the target heat generation rate pattern occurring in the first transition state is also corrected, so the deterioration of the heat efficiency of the engine body 1 and deterioration of the exhaust emission can also be suppressed.

Further, the operating state judging part includes a cylinder state estimating part estimating the trends in the cylinder state when burning fuel by the ignition-assist self-ignition combustion, a predicted self-ignition timing calculating part calculating the predicted self-ignition timing of the remaining fuel based on the trends in the cylinder state, a target self-ignition timing calculating part calculating the target self-ignition timing of the remaining fuel based on the engine operating state, and an advanced deviation calculating part calculating an advanced deviation amount of the predicted self-ignition timing to the advanced side from the target self-ignition timing and the operating state judging part is configured so as to judge that the state is the first transition state (noise transition state) when the advanced deviation amount is larger than a first threshold value (predetermined threshold value).

In this way, by judging if the state is the first transition state based on the advanced deviation amount of the predicted self-ignition timing to the advance side from the target self-ignition timing, it is possible to perform the judgment accurately.

Further, the ozone supply control part is configured so that when the state is judged to be noise transition state, the larger the advanced deviation amount, the smaller the amount of supply or ozone is made relative to the reference amount.

Due to this, it is possible to control the amount of supply of ozone to a suitable amount of supply corresponding to the amount of increase of the combustion noise so as to effectively suppress the deterioration of the combustion noise. This is because the larger the advanced deviation amount, the shorter the time period from the ignition assist timing to the self-ignition timing and the more the amount of fuel consumed by compression-ignition combustion increases relatively and the greater the combustion noise.

Further, the electronic control unit 200 according to the present embodiment is configured so as to be further provided with a retarded deviation calculating part for calculating the retarded deviation amount of the predicted Self-ignition timing to the retarded side from the target self-ignition timing. Further, the ozone supply control part is configured to not control the amount of supply of ozone to the reference amount but to control it to an amount of supply larger than the reference amount when the retarded deviation amount is larger than a second threshold value (predetermined threshold value).

Due to this, it is possible to correct the deviation of the heat generation rate pattern from the target heat generation rate pattern which occurs in the second transition state. For this reason, in the second transition state, it is possible to suppress deterioration of the heat efficiency of the engine body 1 and deterioration of the exhaust emission due to deviation of this heat generation rate pattern.

Further, the ozone supply control part is configured so as to increase the amount of supply of ozone from the reference amount the greater the retarded deviation amount.

Due to this, it is possible to control the amount of supply of ozone to a suitable amount of supply corresponding to the degree of deterioration of the heat efficiency of the engine body 1 or degree of deterioration of the exhaust emission so as to effectively suppress deterioration of the heat efficiency of the engine body 1 or deterioration of the exhaust emission in the second transition state. This is because the larger the retarded deviation amount, the larger the deviation of the heat generation rate pattern and the degree of deterioration of the heat efficiency of the engine body 1 and degree of deterioration of the exhaust emission increase.

Further, if viewing the embodiment from another viewpoint, it can be said that an electronic control unit 200 (control system) for controlling an internal combustion engine 100 provided with an engine body 1, a fuel injector 20 for directly injecting fuel to a combustion chamber 11 of the engine body 1, a spark plug 16 disposed facing the inside of the combustion chamber 11, and an ozone supply system 8 for directly or indirectly supplying ozone to the combustion chamber 11 is configured comprising a combustion control part controlling an injection amount and injection timing of a fuel injector 20 and an ignition timing of the spark plug 16 so as to make part of the fuel burn by the flame-propagation combustion by a spark plug 16 and use the heat generated at that time to make the remaining fuel burn by the premixing- and compression-ignition combustion as an igition-assist self-ignition combustion inside the combustion chamber 11, a cylinder state estimating part estimating the trends in the cylinder state when burning fuel by the ignition-assist self-ignition combustion, a predicted self-ignition timing calculating part calculating the predicted self-ignition timing of the remaining fuel based on the trends in the cylinder state, a target self-ignition timing calculating part calculating the target self-ignition timing of the remaining fuel based on the engine operating state, and an ozone supply control part controlling the amount of supply of ozone based on the difference between the target self-ignition timing and the predicted self-ignition timing.

By controlling the amount of supply of ozone based on the difference between the target self-ignition timing and the predicted self-ignition timing in this way, it is possible to retard or advance just the self-ignition timing without changing the combustion waveform (shape of heat generation rate pattern) during the flame-propagation combustion when the state becomes the transition state. For this reason, it is possible suppress deviation of the heat generation rate pattern from the target heat generation rate pattern in the transition state. As a result, it is possible to suppress deterioration of the combustion noise, the deterioration of the heat efficiency of the engine body 1, and the deterioration of the exhaust emission.

### Second Embodiment

Next, a second embodiment will be explained. The present embodiment differs from the first embodiment on the point of controlling the amount of supply of ozone to suppress deterioration of the combustion noise when the engine load is a predetermined load or more in the self-ignition region RR. Below, this point of difference will be focused on for the explanation.

As explained above referring to FIG. 5, when making the premixed gas burn by the compression-ignition combustion, the combustion noise increases the greater the amount of fuel consumed by the compression -ignition combustion. For this reason, in the engine low load region where the total fuel injection amount Q_{INJ}1 is originally small, even if the state becomes the first transition state and the combustion noise increases, sometimes it falls within the allowable noise value. Therefore, in such an engine low load region, when the state becomes the first transition state, it is not necessarily required to reduce the amount of supply of ozone from the reference amount to suppress deterioration of the combustion noise.

Here, the target injection timing A_{INJ}1 of the main fuel basically tends to become more advanced the higher the engine rotational speed and, further, the higher the engine load. Therefore, for example, when advancing the target injection timing A_{INJ}1 of the main fuel the higher the engine load, the injection timing of the main fuel is retarded the lower the engine load. This being so, the injection timing of the main fuel is set to the relatively second half of the compression stroke in the engine low load region. For this reason, the main fuel is injected in the combustion chamber 11 when the cylinder pressure P and cylinder temperature T are relatively high.

Ozone changes to oxygen more easily the higher the cylinder pressure P and cylinder temperature T. For this reason, in the engine low load region, until the main fuel is injected, the amount of ozone ending up changing to oxygen without generating oxygen radicals increases. This being so, after injecting main fuel, the amount of oxygen radicals reacting with the main fuel decreases. For this reason, in the engine low load region, the controllability of the self-ignition timing by control of the amount of supply of ozone is liable to deteriorate.

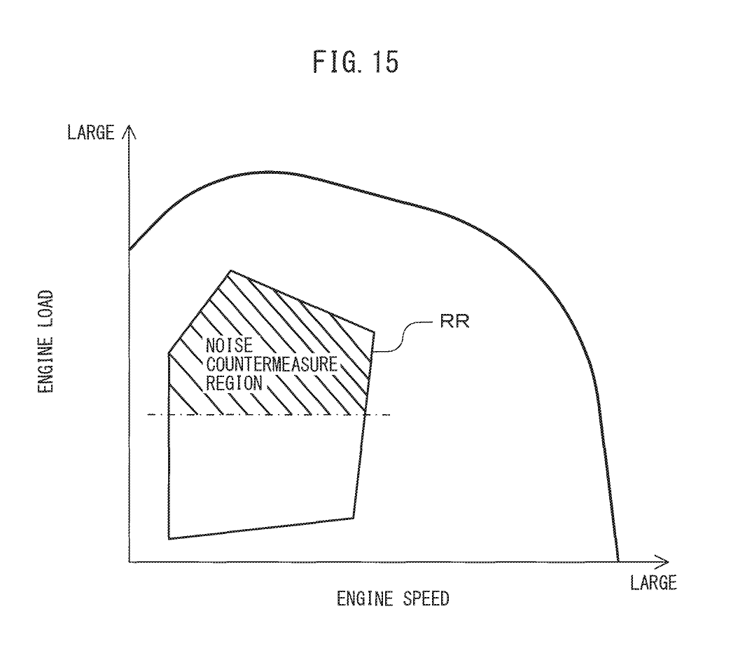

Therefore, in the present embodiment, as shown in FIG. 15, if inside the noise countermeasure region where the engine load is the predetermined load or more in the self-ignition region RR, the amount of supply of ozone is decreased from the reference amount to suppress deterioration of the combustion noise when in the first transition state while if outside of the noise countermeasure region in the self-ignition region RR, the injection timing and ignition assist timing of the ignition assist fuel are retarded from the target values to suppress deterioration of the combustion noise.

Due to this, in the noise countermeasure region, it is possible to control the amount of supply of ozone to easily control the self-ignition timing and, further, possible to keep the combustion noise within the allowable noise value or less. On the other hand, outside of the noise countermeasure region, it is possible to retard the injection timing and ignition assist timing of the ignition assist fuel from the target values to thereby enable easy control of the self-ignition timing without causing deterioration of the controllability of the self-ignition timing.

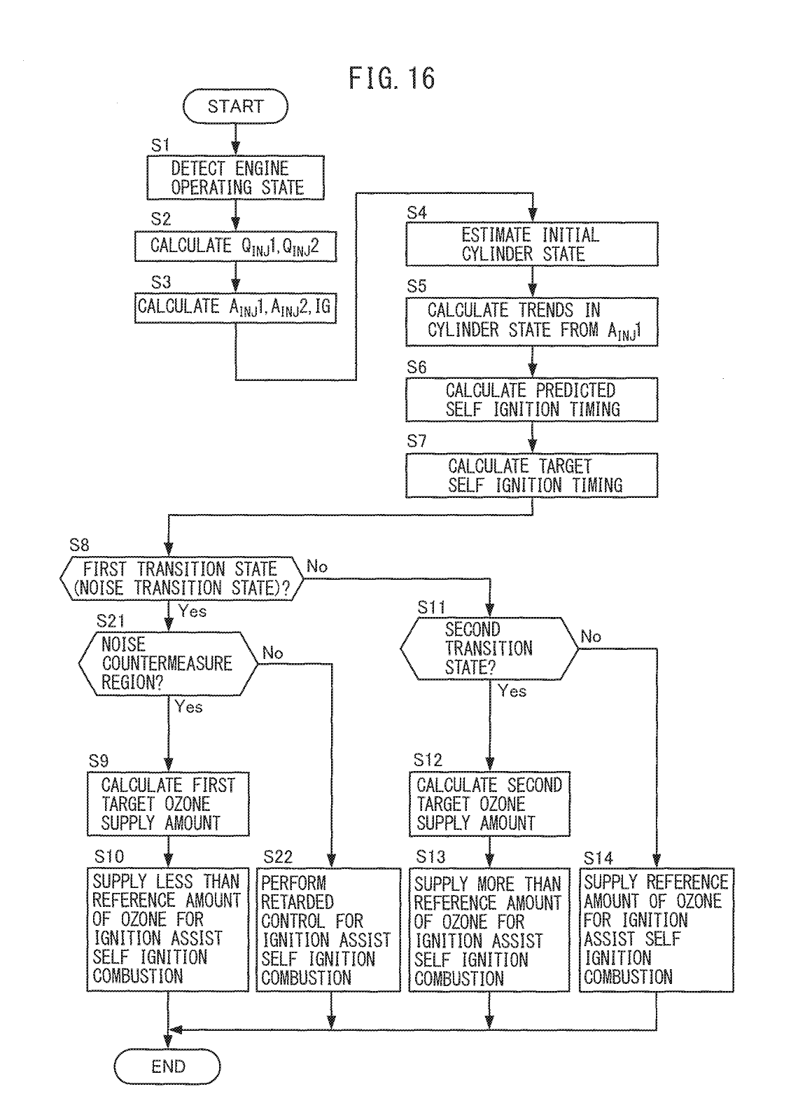

FIG. 16 is a flow chart for explaining the control of combustion during the CI operating mode according to the present embodiment. The electronic control unit 200 repeatedly performs the present routine by a predetermined processing period (for example, 10 ms) during the CI operating mode.

The processing from step S1 to step S14 is processing similar to the first embodiment, so the explanation will be omitted here.

At step 521, the electronic control unit 200 judges if the engine operating state is in the noise countermeasure region. The electronic control unit 200 proceeds to the processing of step 59 if the engine operating state is in the noise countermeasure region. On the other hand, the electronic control unit 200 proceeds to the processing of step S22 if the engine operating state is outside the noise countermeasure region in the self-ignition region RR.

At step S22, the electronic control unit 200 controls the ozone supply system S so that the amount of supply of ozone to the inside of the combustion chamber 11 becomes the reference amount and retards the target values of the injection timing and ignition assist timing of the ignition assist fuel calculated at step S3 by exactly the advanced deviation amount Tiga to perform an ignition-assist self-ignition combustion.

Above, embodiments were explained, but the above embodiments only show part of the examples of Application of the present disclosure and do not limit the technical scope of the present disclosure to the specific configurations of the above embodiments.

For example, in the above embodiments, when the state is judged to be the second transition state, the amount of supply of ozone was increased over the reference amount to keep the heat generation rate pattern from changing from the target heat generation rate pattern. However, in the second transition state, the combustion noise itself does not become a problem, so it is also possible to advance the injection timing and ignition assist timing of the ignition assist fuel to keep the heat generation rate pattern from changing from the target heat generation rate pattern.

Further, in the second embodiment, at step S22, the reference amount of ozone was supplied to the inside of the combustion chamber 11, but it is also possible to not supply ozone but to retard the injection timing and ignition assist timing of the ignition assist fuel to burn fuel by the ignition-assist self-ignition combustion.

1. A control system for an internal combustion engine configured so as to control an internal combustion engine provided with:
an engine body;
a fuel injector for directly injecting fuel into a combustion chamber of the engine body;
a spark plug arranged so as to face the inside of the combustion chamber; and
an ozone supply system for supplying ozone directly or indirectly into the combustion chamber, the control system comprising:
a combustion control part configured to control an injection amount and injection timing of the fuel injector and an ignition timing of the spark plug so as to cause part of the fuel to burn by the flame-propagation combustion by the spark plug and use heat generated at that time to make, the remaining fuel burn by the premixing- and compression-ignition combustion as an ignition-assist self-ignition combustion in the combustion chamber;
an operating state judging part configured to judge if an engine operating state is a steady state or a noise transition state where the combustion noise increases over a predetermined allowable noise value when burning fuel by the ignition-assist self-ignition combustion; and
an ozone supply control part configured so as to control the amount of ozone supplied to the combustion chamber by the ozone supply system, and
the ozone supply control part being further configured so as to:
control the amount of supply of ozone to a predetermined reference amount when the state is judged to be the steady state; and
control the amount of supply of ozone to an amount of supply smaller than the reference amount or make the amount of supply of ozone zero when the state is judged to be the noise transition state.

2. The control system for an internal combustion engine according to claim 1, wherein
the operating state judging part includes:
a cylinder state estimating part configured to estimate the trends in the cylinder state when burning fuel by the ignition-assist self-ignition combustion;
a predicted self-ignition timing calculating part configured to calculate the predicted self-ignition timing of the remaining fuel based on the trends in the cylinder state;
a target self-ignition timing calculating part configured so as to calculate the target self-ignition timing of the remaining fuel based on the engine operating state; and
an advanced deviation calculating part configured to calculate the advanced deviation amount of the predicted self-ignition timing to the advance side from the target self-ignition timing, and
the operating state judging part is further configured to judge that the state is the noise transition state when the advanced deviation amount is larger than a predetermined threshold value.

3. The control system for an internal combustion engine according to claim 2, wherein
the ozone supply control part is further configured so as to reduce the amount of supply of ozone from the reference amount the larger the advanced deviation amount when it is judged that the state is the noise transition state.

4. The control system for an internal combustion engine according to claim 2, wherein
the control system is further comprised a retarded deviation calculating part configured so as to calculate the retarded deviation amount of the predicted self-ignition timing to the retarded side from the target self-ignition timing, and
the ozone supply control part is further configured to not control the amount of supply of ozone to the reference amount but to control it to an amount of supply larger than the reference amount when the retarded deviation amount is larger than a predetermined threshold value.

5. The control system for an internal combustion engine according to claim 4, wherein
the ozone supply control part is further configured so as to increase the amount of supply of ozone from the reference amount the larger the retarded deviation amount.

6. The control system for an internal combustion engine according to claim 1, wherein
the ozone supply control part is further configured to control the amount of supply of ozone to an amount of supply smaller than the reference amount or make the amount of supply of ozone zero when the engine load when judging the state is the noise transition state is a predetermined load or more.

7. A control system for an internal combustion engine configured so as to control an internal combustion engine provided with:
an engine body;
a fuel injector for directly injecting fuel into a combustion chamber of the engine body;
a spark plug arranged so as to face the inside of the combustion chamber; and
an ozone supply system for supplying ozone directly or indirectly into the combustion chamber,
the control system comprising:
a combustion control part configured to control an injection amount and injection timing of the fuel injector and an ignition timing of the spark plug so as to cause part of the fuel to burn by the flame-propagation combustion by the spark plug and use heat generated at that time to make the remaining fuel burn by the premixing- and compression-ignition combustion as an ignition-assist self-ignition combustion in the combustion chamber;
a cylinder state estimating part configured so as to estimate the trends in the cylinder state when burning fuel by the ignition-assist self-ignition combustion;
a predicted self-ignition timing calculating part configured so as to calculate the predicted self-ignition timing of the remaining fuel based on the trends in the cylinder state;
a target self-ignition timing calculating part configured so as to calculate the target self-ignition timing of the remaining fuel based on the engine operating state; and
an ozone supply control part configured so as to control the amount of supply of ozone based on the difference between the target self-ignition timing and the predicted self-ignition timing.
